(19) United States
(12) Patent Application Publication
(10) Pub. No.: US 2017/0225508 A1
(43) Pub. Date: Aug. 10, 2017

(54) Paint palette for painting ceilings

(71) Applicant: TULKO HARDWARE, LLC, Tulsa, OK (US)

(72) Inventor: Ben Mayberry, Tulsa, OK (US)

(21) Appl. No.: 14/999,544

(22) Filed: May 23, 2016

Related U.S. Application Data
(63) Continuation-in-part of application No. 13/815,658, filed on Mar. 14, 2013, now Pat. No. 9,656,513.
(60) Provisional application No. 61/685,281, filed on Mar. 15, 2012.

(51) Int. Cl. B44D 3/02; A46B 17/02; B44D 3/12

(52) U.S. Cl. CPC B44D 3/02; B44D 3/127; A46B 17/02

(57) ABSTRACT

A paint palette for painting ceilings while on a ladder or scaffolding wherein a painter or muralist can lay on their back and paint a ceiling or other structure from a paint palette that will retain paint when used upside down.

### BACKGROUND

Field of the Invention

This invention relates to a painters tool that allows a painter to paint a ceiling or other structure while lying on their back and incorporates an antigravity paint pallet that can be used in an upside down position without spilling paint.

Discussion of Prior Art

A paint palette is a tool typically used by an artist and is used to provide a hand held platform to hold paint. The paint palette is typically made of wood or plastic and holds numerous colors of paint upon which an artist dabs their brush to retain paint before being applied to a surface.

Typically, an artist uses a paint pallet when painting upon a canvas. This system works well for an artist painting with acrylics or watercolors when the paint pallet is held upright, but if the paint pallet were held at an angle or turned upside down, the paint would run off the pallet.

In general, a paint pallet is a useful tool, but in some cases, a painter is required to paint a surface above their head such as a ceiling or other high surface. Many painters find it difficult to repeat the action of looking down to apply paint and repeatedly raise the paint brush above their head to apply paint to a surface.

All prior art regarding painters palette tools are designed for standing or sitting in an upright position. There are no available tools to assist painters that need to paint above their head while standing or while laying on their back on a scaffolding platform.

Painters have a need for a paint pallet that could retain paint while in an upside down position. Such a tool would reduce fatigue and stress due to the current requirement to look down and load the brush and then to look up and apply the paint to the structure above the painters head.

A paint pallet that could be used upside down could also allow a painter to lie comfortably on their back while holding a pallet above them while positioned in a more comfortable position.

Additionally, a painter could lay on a scaffold with access to multiple colors of paint on the improved paint pallet and apply more colors much more easily than existing products allow.

Additionally, prior art has not shown us a useful means for transporting, storing or viewing paint colors while in storage. Prior art has not provided a truly useful painters tool that allows a painter to truly speed up the painting process in a neat and effective way.

The term “antigravity” typically means that a substance is not subject to gravity and as such will not drop to the ground. The term “antigravity paint pallet” as used in this specification is used to describe the action of the paint on the pallet. When paint is loaded onto the paint pallet, the paint will not spill on to the ground, even when dropped.

Of all the available prior art products utilized by a painter today, none will allow a painter to load paint on a pallet, tip it upside down and then extend climb a ladder or scaffolding structure and paint in an upside down or inverted position without fear of paint spilling off the paint pallet.

There is also a no current means to use multiple colors in an upside down angle and to paint a ceiling and eliminate the need for paint cans to be lifted to the ceiling area.

### SUMMARY OF THE INVENTION

The paint palette for painting ceilings is a new unique painting tool for commercial painters and muralist who need to paint in an upside down position meaning that painter is looking up and painting above their head. The described invention fills a need for both professional and non-professional painters. The invention provides an improved way to contain paint and move up a ladder or scaffolding without spillage and to paint ceilings or high structures with the pallet upside down from normal use.

The paint palette for painting ceilings allows the painter to focus on painting without worry of accidental spills. A painter will also not have to worry about accidentally knocking over a paint can or having to reload the brush. The paint palette for painting ceilings reduces trips up and down ladders or scaffolds.

The paint palette for painting ceilings is drip-less and mess free. Even a child could paint a ceiling without spilling paint. In actual testing the paint palette for painting ceilings was loaded with paint and dropped upside down from a roof without any loss of paint or any spillage.

The paint palette for painting ceilings allows for easy storage and reuse of paint. The complete paint palette tool system can be easily stored for extended periods of time in commercially available seal type plastic bags because of its low profile design.

The paint palette for painting ceilings allows for a painter to worry less about mess and more about painting. The paint palette for painting ceilings allows for a painter to paint without the use of drop cloth protection. The antigravity paint palette saves the painter clean up time and speeds up painting time.

A painter can now climb a ladder or scaffold to paint a ceiling, roof or elevated area without handling full cans of paint. A painter can even take multiple colors to remote or high locations without worrying about carrying multiple paint cans to risky locations.

Several objects and advantages of the disclosed invention are provided including but not limited to an improved paint tool for painting ceilings wherein a painter can paint a ceiling or high structure more efficiently and faster without having to carry multiple cans of paint up a ladder or scaffolding structure.

The paint palette for painting ceilings allows a painter to lie upon their back in a comfortable position while painting in an upside down position using multiple colors of paint. No other tool exists that allows a painter to lay upon their back and paint a ceiling with ease.

Other objects and advantages of the invention include providing a paint containment and dispensing low profile container that is spill proof and easily transported. The paint palette for painting ceilings is easily manageable, carried and allows for easy sealed containment for an extended time, thus reducing clean up and allowing for easy storage.

When in use, the paint palette for painting ceilings will not drip paint on unprotected surfaces thus eliminating the need for drop cloths and other protective coverings, thus saving time and labor cost.

Because of the way the paint palette for painting ceilings retains paint and will not spill or drip even when turned upside down or dropped, the paint brush is loaded more efficiently and uses less paint, thus saving paint.

Because of the improved paint retaining ability of the paint palette for painting ceilings the paint brush or roller is loaded in an improved fashion. The paint tools become easier to use and better disperses the paint.

Further objects and advantages of the invention will become apparent from consideration of the drawings and ensuing description. Paint accessories may also be added to the paint palette for painting ceilings and may include tools such as a squeegee, a covering means or add-on attachments for managing a paint brush or other paint tools.

The foregoing and other objectives, features, and advantages of the paint palette for painting ceilings will be more readily understood upon the consideration of the following detailed description of the invention.

### DESCRIPTION OF THE DRAWINGS

FIG. 1 is a top plan view;

FIG. 2 is a right end view, the opposite side bring a mirror image;

FIG. 3 is a bottom plan view;

FIG. 4 is an end view taken from FIG. 3, the opposite side being a mirror image;

FIG. 5 is an exploded perspective view of the first embodiment;

FIG. 6 is an assembled perspective view of the first embodiment;

FIG. 7 is a plan view of the squeegee

FIG. 8 is a sectional view taken from the FIG. 1;

FIG. 9 is an exploded perspective view showing a second embodiment;

FIG. 10 is an exploded perspective view showing liner placement of the first embodiment;

FIG. 11 is an exploded perspective view showing liner placement of the second embodiment;

FIG. 12 is an exploded perspective view showing liner flipped and used as a lid;

FIG. 13 is a perspective view showing loading of paint;

FIG. 14 is a perspective view showing loading of paint brush;

### DESCRIPTION OF THE INVENTION

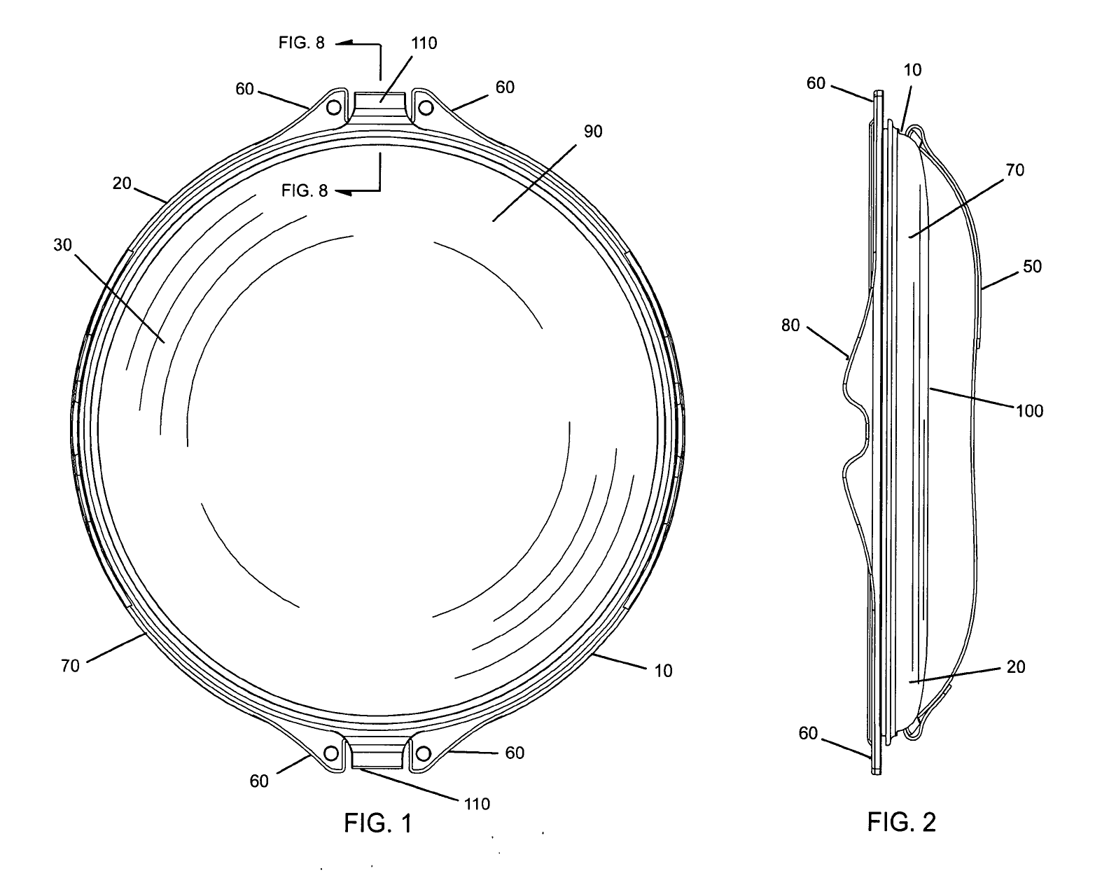

FIG. 1 shows a top plan view of the basic embodiment of the paint palette for painting ceilings 10 herein after called the invention wherein the main body of the invention comprises an exterior open-top structure constructed of a semi-rigid plastic material in a circular configuration and shall act as an outer shell 20.

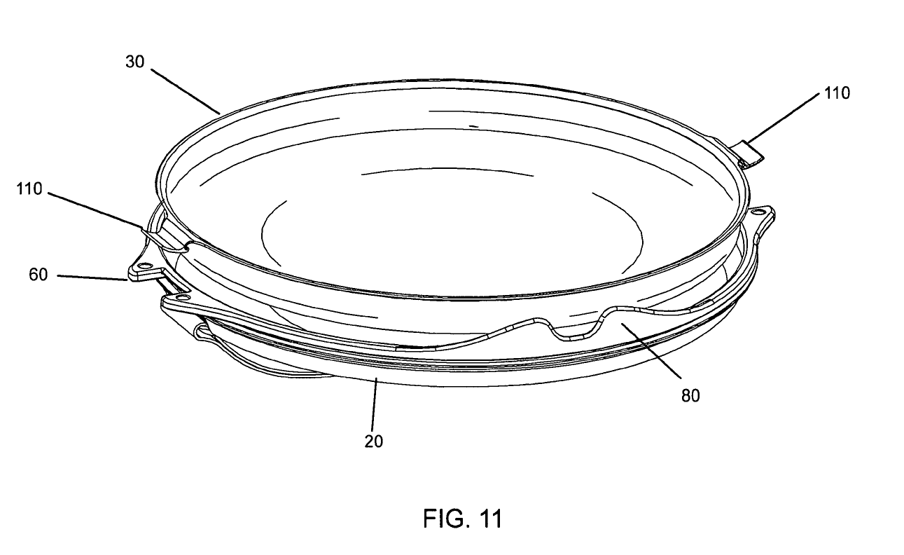

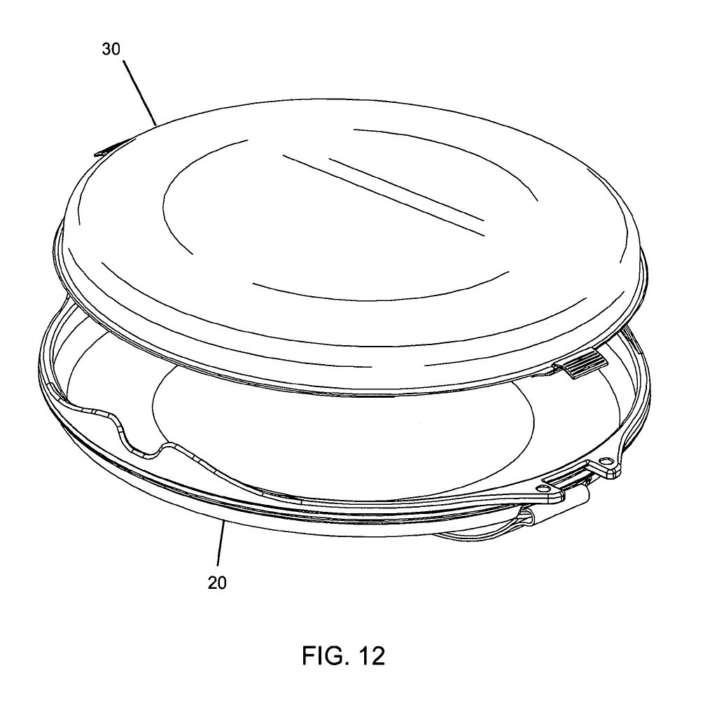

In the first embodiment the invention 10 has an outer shell 20 designed for receiving a removable liner 30 wherein the removable liner 30 nest within the outer shell 20 in a complementary snap in fashion. Shown in FIG. 11

The removable liner 30 acts as a protective liner and shall be constructed of a thinner and lighter design. The outer shell 20 shall have a heavier and more solid construction.

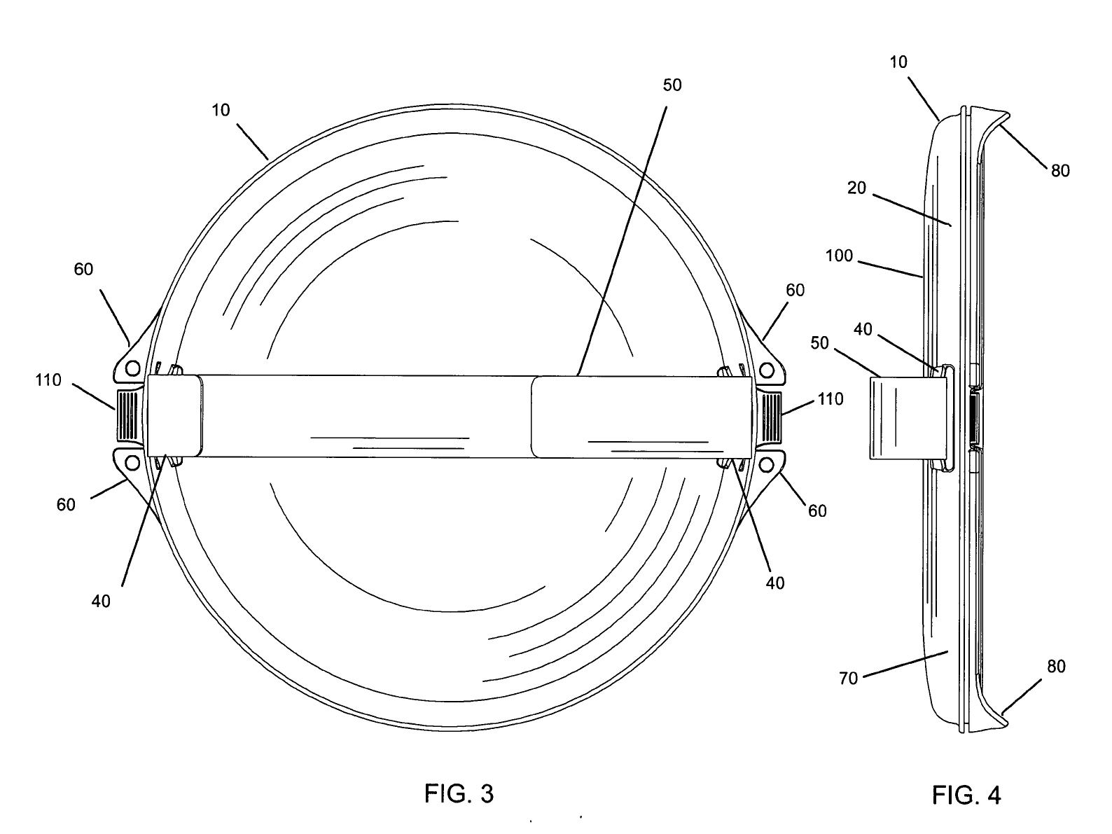

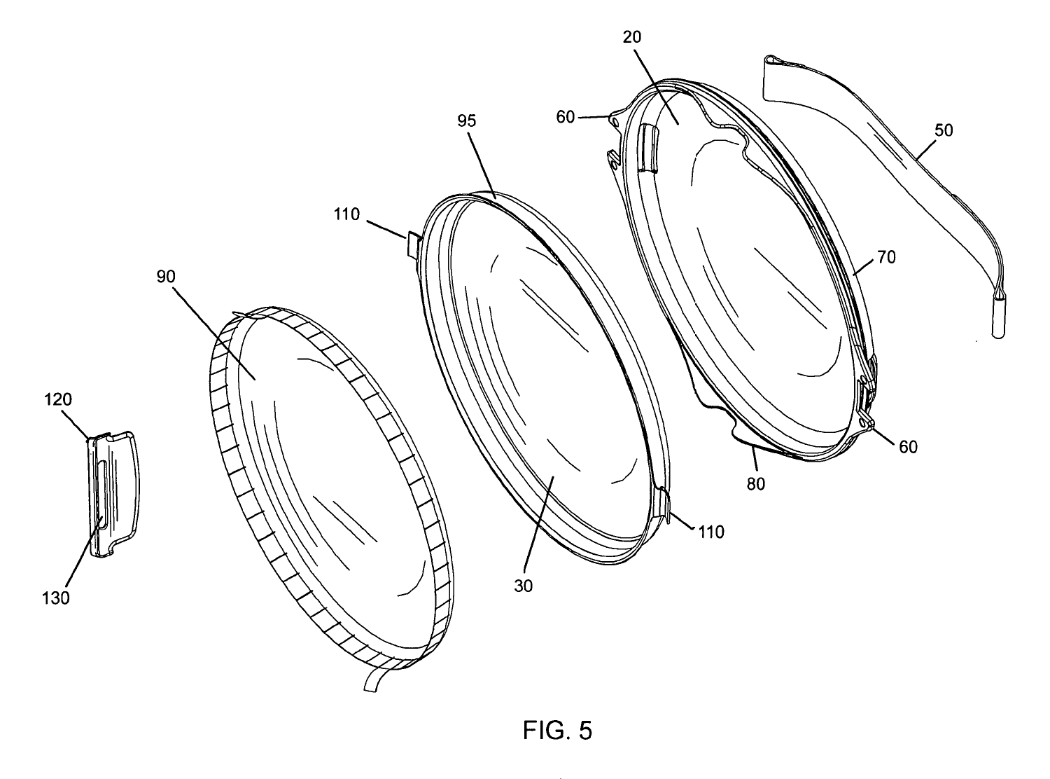

The outer shell 20 shall have a pair of strap connectors 40 on the outer periphery on the bottom surface placed on opposite sides of the circular shape as shown in FIG. 3. The strap connectors 40 designed for receiving an adjustable strap 50 that shall extend across the bottom side of the outer open-top structure shown in FIG. 2, 3, 4 and FIG. 5. A cross section detail is shown in FIG. 8

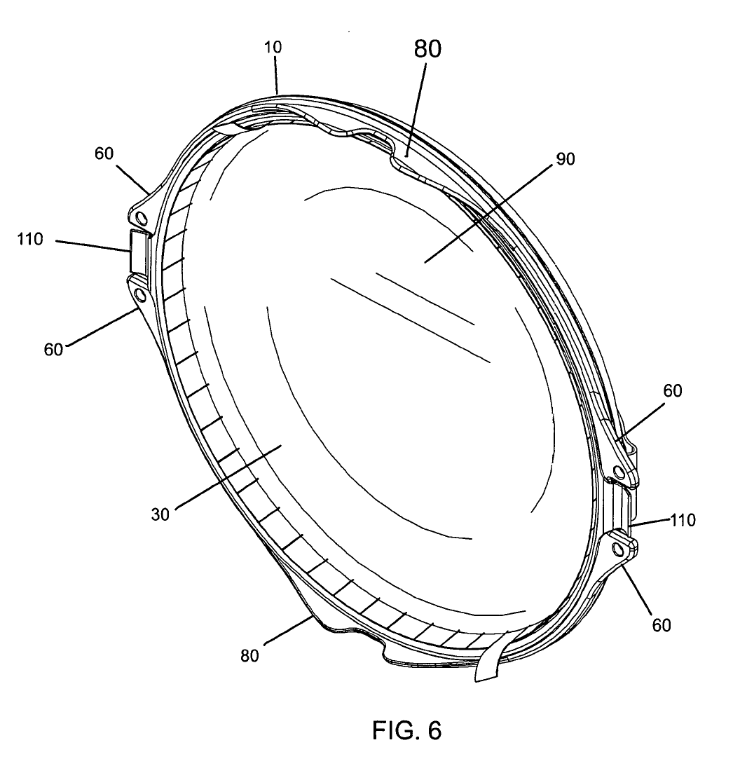

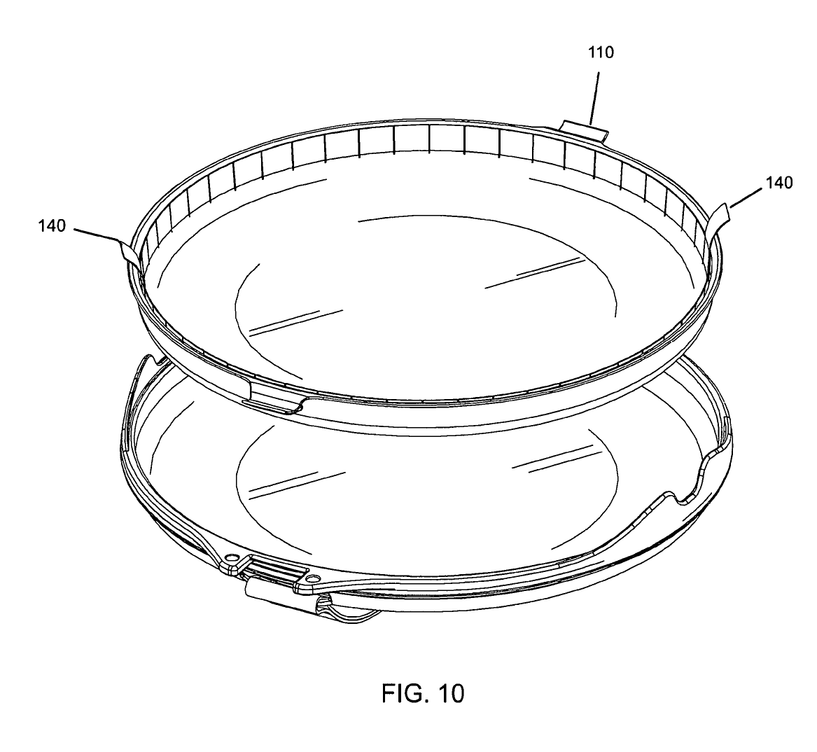

The outer shell 20 shall have on the upper open side of the structure and in alignment with strap connectors 40 a pair of sidewall extensions 60 shall extend out from the circular periphery as seen in FIG. 1, FIG. 6 and FIG. 10 for alignment of removable liner 30.

The outer shell 20 shall have a low profile side wall 70 encompassing the structure and side wall shall additionally have a pair of raised wall extensions 80 shown in FIG. 2 located perpendicular to the strap connector 40 shown in FIG. 5.

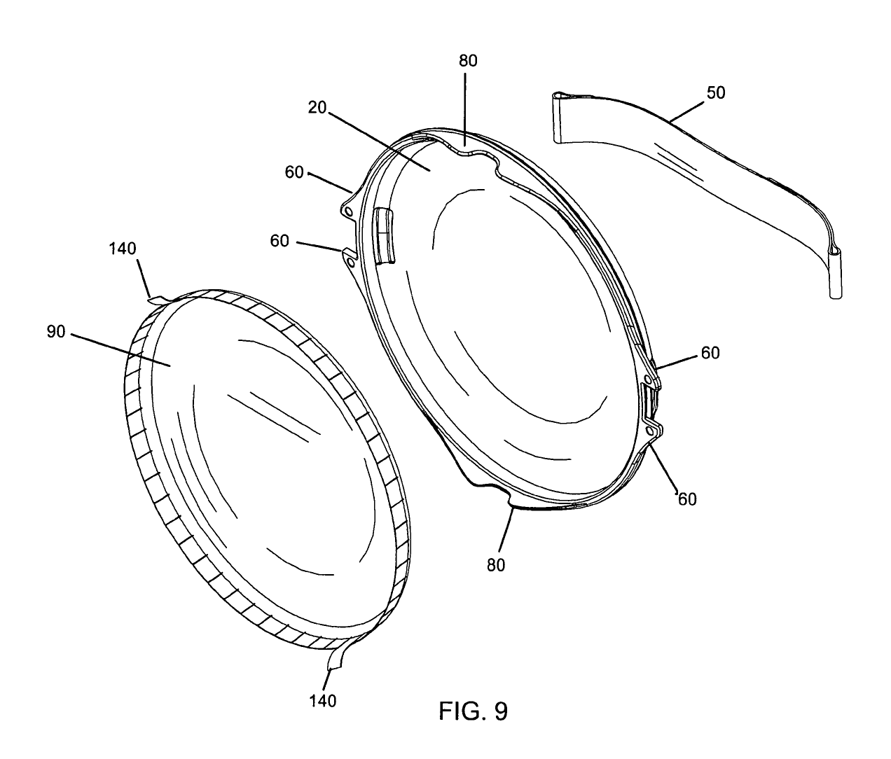

The removable liner 30 shall have a paint retaining bristle fabric 90 affixed to the inner cavity shown in FIG. 1. and FIG. 9. The bristle fabric 90 is typically used on paint application devices and is a commercially available fabric material comprising a short bristle filaments that hold and retains paint.

The paint retaining bristle fabric 90 shall fit inside the removable liner 30 and shall completely cover the bottom surface and sidewall 95 of the removable liner 30.

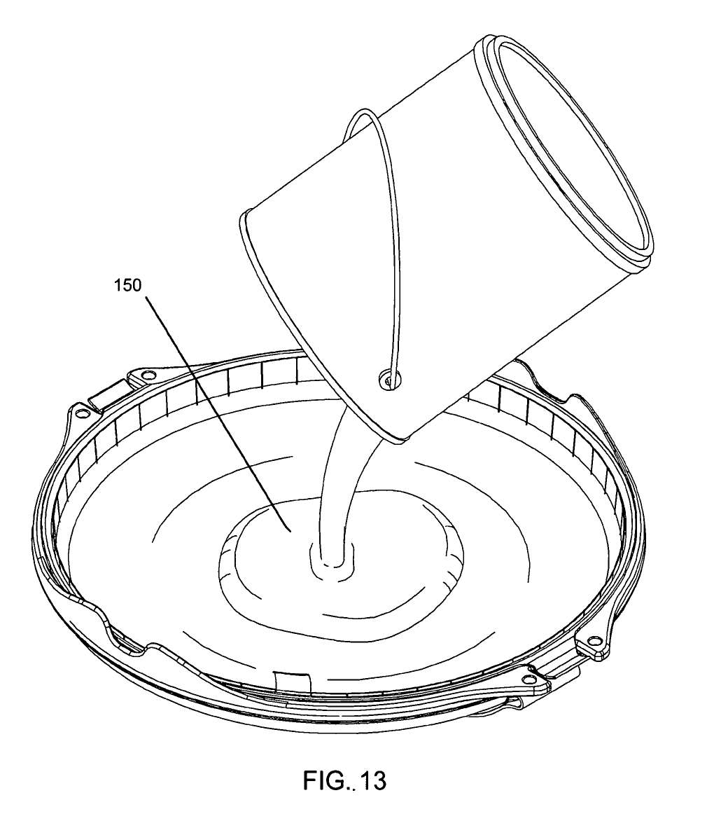

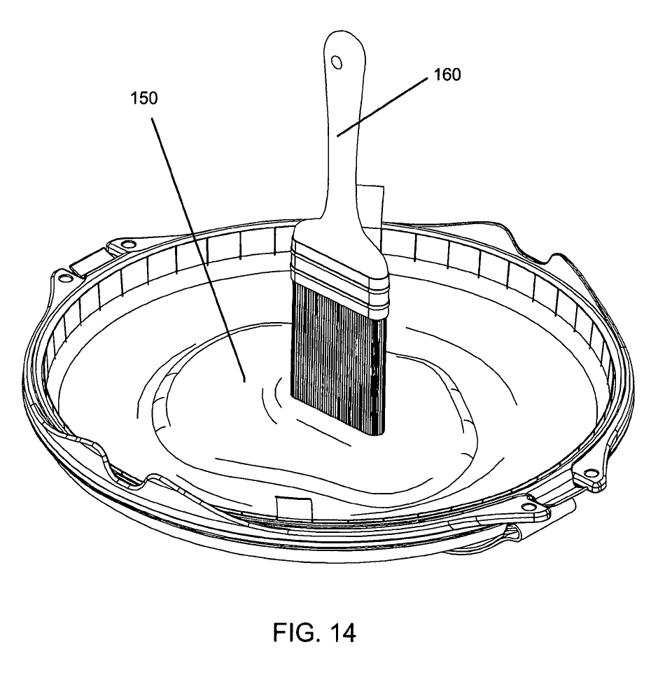

The paint retaining bristle fabric 90 shall be fitted and affixed by a commercially available glue or adhesive applied to the backside of the paint retaining bristle fabric 90 and affixed to the interior bottom surface of removable liner 30. Shown in FIG. 10, FIG. 13 and FIG. 14.

The paint retaining bristle fabric 90 shall be circular cut and complementary to the shape and size of the removable liner 30 and shall have a die cut design to provide for a simple and centered application shown in FIG. 5.

Removable liner 30 shall be constructed of a flexible semi rigid plastic or like material comprising a substantially flat bottom base 100 with enclosing sidewall 95. Sidewall 95 formed in a rounded outwardly inclined shape as seen in FIG. 8.

Sidewall 95 shall be rigid and shall extend no more than two inches in height. The removable liner 30 shall be configured to be a low profile design and shall match the height of the outer shell 20. Shown is FIG. 8.

The removable liner 30 shall have a ridge sidewall 95 as seen in FIG. 8 and shall have a pair of extended tabs 110 to allow the removable liner to snap into the outer shell 20 in a complementary fashion as seen in FIG. 3, FIG. 5 and further detailed in FIG. 8 cross section.

The adjustable strap 50 shall extend across the bottom surface on the exterior surface of the open-top structure 20 and will attach to opposite ends of the open-top structure 20 looping thru the fastener connectors 40 and shall provide a user handle for the assembled invention 10 shown in FIG. 2.

The adjustable strap 50 shall be a suitable length to be passed thru strap connections 40 on each end and shall have excess length to allow for adjustments. Adjustable strap 50 shall have VELCRO securely applied to the adjustable strap for adjustment of length and fit. Shown is FIG. 2.

The adjustable strap 50 shall be constructed of a flexible fabric material and may be made of a durable cloth fabric or like material. Strap connectors 40 shall be formed into the outer shell 20.

In the first embodiment the removable liner 30 may be removed and flipped over to also become a sealable lid to the outer shell 20 thus providing a novel way to store the paint when not in use. Shown in FIG. 12.

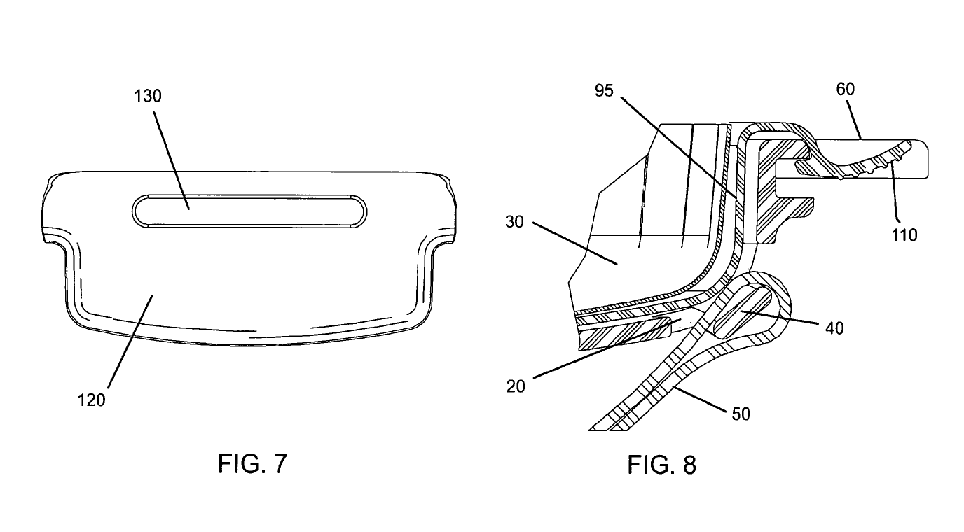

A hard plastic squeegee 120 Shown in FIG. 7 is also supplied with a unique design serving multiple uses. The squeegee may be used to scrape paint on the paint retaining bristle fabric 90 surface to a particular area and to better allow the painter to use multiple colors.

The squeegee 120 shall have a slot 130 in the main body as seen in FIG. 5 and FIG. 7 designed for receiving the adjustable strap 50. By sliding the adjustable strap 50 thru the slot 130 in the body of the squeegee 120 and using the squeegee as a support leg, the invention 10 angle may adjusted in height on either end of the invention 10 making the invention 10 slanted and more suitable for using a roller.

In use the invention 10 is utilized by pouring paint 150 into the removable liner 30, Shown in FIG. 13 and then sliding the users hand between the body of the invention 10 and the adjustable strap 50. The painter may now turn the invention upside down and no paint will be spilled.

In use the invention 10 may have multiple colors of paint in the container or a single color as shown in FIG. 14 and a painter may lay upon their back on a scaffolding and use a paint brush 150 paint a ceiling in an improved manner.

In a second embodiment of the invention 10 the removable liner 30 is eliminated and the paint retaining bristle material 90 is affixed directly to the interior cavity of the outer shell 20 in a complementary fashion. Shown in FIG. 9.

In the second embodiment the bristle fabric 90 shall be replaceable and have a pair if extended tabs 140 on opposite ends of the circular design for ease in application and removal. Once the bristle fabric 90 is worn the user pulls out the old bristle fabric 90 using the tabs 140 and inserts a new bristle fabric 90 insert directly into the outer shell 20.

Although applicant has described applicant's preferred embodiment of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

From the foregoing, it will be apparent that the described invention 10 provides for a novel and improved way for a painter or muralist to paint a ceiling while laying upon their back and whereas the present invention has been described in a particular fashion, it should be understood that other and further modifications apart from those shown or suggested herein may be made within the scope of the invention.
10—Invention
20—Outer Shell
30—Removable Liner
40—Strap connector
50—Adjustable Strap
60—Sidewall extensions
70—Outer shell low profile sidewall
80—Raised wall extension
90—Paint retaining bristle fabric
95—Sidewall of liner
100—Flat bottom base
110—Extended tabs of removable liner
120—Squeegee
130—Slot in body of squeegee
140—Bristle fabric extended tabs
150—Paint
160—Paint Brush

What is claimed is:

1. A paint palette for painting ceilings comprising a exterior low profile open-top structure comprising an outer shell with an interior low profile open-top container comprising a removable liner nested within the outer shell with liner having a paint retaining bristle fabric affixed within its cavity for retaining paint when used upside down and outer shell having an adjustable handle extending the width of the bottom exterior of structure supplied with a paint squeegee.

2. A paint palette for painting ceilings as described in claim 1 wherein outer shell can also be used as a lid for a standard five gallon paint container.

3. A paint palette for painting ceilings as described in claim 1 wherein strap is slid into the slot in the squeegee body and provides a support leg for improved paint roller use.

4. A paint palette for painting ceilings as described in claim 1 wherein strap is designed to have openings for attaching brushes.

5. A paint palette for painting ceilings comprising a low profile open-top structure having a paint retaining bristle fabric affixed within its cavity for retaining paint when upside down and an adjustable handle extending the width of the bottom exterior of the structure supplied with a paint squeegee.

6. A paint palette for painting ceilings as described in claim 2 wherein outer shell can also be used as a lid for a standard five gallon paint container.

7. A paint palette for painting ceilings as described in claim 2 wherein outer shell has a snap position for affixing squeegee.
